(19) United States
(12) Patent Application Publication
(10) Pub. No.: US 2019/0242506 A1
(43) Pub. Date: Aug. 8, 2019

(54) Pipe Clamp

(71) Applicant: Termax LLC, Lake Zurich, IL (US)

(72) Inventor: Daniel James Dickinson, Lincolnshire, IL (US)

(73) Assignee: Termax LLC, Lake Zurich, IL (US)

(21) Appl. No.: 16/268,482

(22) Filed: Feb. 5, 2019

Related U.S. Application Data
(60) Provisional application No. 62/626,199, filed on Feb. 5, 2018.

(51) Int. Cl. F16L 23/04

(52) U.S. Cl. CPC F16L 23/04

(57) ABSTRACT

A semicircular pipe clamp is operable to couple a first pipe flange and a second pipe flange. The clamp has a first end and a second end opposite the first end. The first end of the pipe clamp has a first window. The first window is formed by a first ring and a second ring. The first ring has a first curvature operable to engage the first pipe flange. The second ring has a second curvature opposite the first ring operable to engage the second pipe flange. The second end is opposite the first end and has a second window. The second window is formed by a third ring and a fourth ring. The third ring has the first curvature operable to engage the first pipe flange. The fourth ring has the second curvature opposite the third ring operable to engage the second pipe flange.

### RELATED APPLICATIONS

This application is a non-provisional application, which claims priority from provisional application 62/626,199 filed on Feb. 5, 2018 and owned by the instant assignee.

### FIELD OF THE INVENTION

The invention relates generally to Pipe couplers to hold pipes or to attach onto pipes such as a heat exchanger or radiator.

### BACKGROUND OF THE INVENTION

A number of devices and fasteners are currently available to couple pipes. For example, pipe clamps typically compress an outer pipe or hose to an inner pipe. Clamps compress pipes together via crimp, cinch, spring or screw. These clips are oriented horizontally or perpendicular to the axis of the pipes to hold the flanges together. However the horizontal orientation of these clip results in a relatively weak coupling because the bend in the sheet metal can easily bend the ends apart. Further, since the length of the clamp is relatively long, the clamp expands as the temperature increases further reducing the compression and tension of the U clamp. If clamp tension due to age, vibration or temperature is reduced then the coupling between the pipes can reduce the insertion pressure on the compression gasket and a leak can occur. Threaded clamps require fastening with a screw driver or wrench and thus are cumbersome and difficult to install especially in inaccessible areas. Nor can they be installed without a screw driver or wrench. Further, replacement of an installed, broken clamp, screw crimp, or cinch, can again be difficult.

### BRIEF DESCRIPTION OF THE DRAWINGS

FIG. 1 is an exploded view of a semicircular pipe clamp assembly to one embodiment;

FIG. 2 is a partially assembled view of a semicircular pipe clamp assembly operable to attach to a heat exchanger according to another embodiment;

FIG. 3 is a perspective view of a semicircular pipe clamp assembly according to one embodiment;

FIG. 4 is a side view of a semicircular pipe clamp assembly according to one embodiment;

FIG. 5 is a bottom perspective view of a semicircular pipe clamp assembly according to one embodiment;

FIG. 6 is a perspective view of a semicircular pipe clamp according to one embodiment;

FIG. 7 is a side view of a semicircular pipe clamp; and

FIG. 8 is a longitudinal side view of a semicircular pipe clamp;

### DETAILED DESCRIPTION OF THE PREFERRED EMBODIMENTS

A semicircular pipe clamp is operable to couple a first pipe flange and a second pipe flange. The clamp has a first end and a second end opposite the first end. The first end of the pipe clamp has a first window. The first window is formed by a first ring and a second ring. The first ring has a first curvature operable to engage the first pipe flange. The second ring has a second curvature opposite the first ring operable to engage the second pipe flange. The second end is opposite the first end and has a second window. The second window is formed by a third ring and a fourth ring. The third ring has the first curvature operable to engage the first pipe flange. The fourth ring has the second curvature opposite the third ring operable to engage the second pipe flange.

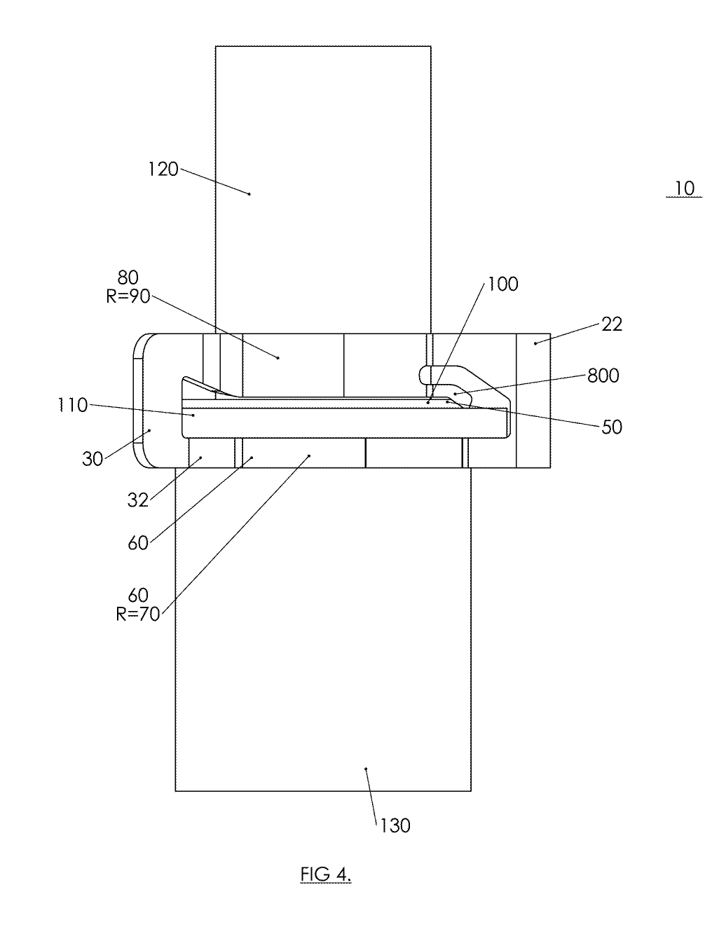

Among other advantages, the semicircular pipe clamp is oriented parallel to the axis of the pipes to hold the flanges together. For example, a rectangular beam, an I-beam or other beam where the vertical height is greater than the width or depth resists longitudinal forces compared to bending forces applied to the horizontally oriented clips. Examining the deflection shape of a beam model for each ring, for a force applied from the top of the generally beam it is possible to observe that longitudinal elements of the beam near the bottom are stretched and those near the top are compressed, thus indicating the simultaneous existence of both tensile and compressive stresses on transverse planes. Examining the deflection shape of FIG. 4 where the flanges are pushing apart from each other, each ring has longitudinal elements of the ring away from the flanges are stretched and those near the flanges are compressed, thus indicating the simultaneous existence of both tensile and compressive stresses on transverse planes of each ring.

Because the material is oriented parallel to the axis of the pipes (as shown in the figures: vertically rather than horizontally) material better resists separation between the rings and thus maintains the flanges in tight compression. Like an I beam, the clamp is taller than it is deep, the clamp resists longitudinal bending. As a result, the pipe clamp maintains the flanges in tension in the presence of age, vibration or temperature and is superior to horizontally oriented clips.

According to one embodiment, the flange of one pipe has a larger diameter of the other pipe so the smaller diameter pipe fits into the larger diameter flange. As one skilled in the art would understand, a gasket on the smaller diameter pipe provides a sufficient seal for any suitable application, such as for a radiator, heater core, intercooler, air conditioning condenser, compressor or any suitable device. As such the pipe clamp keeps the pipes couple together such that the gasket sufficiently seals the inner diameter pipe to the outer pipe having a larger diameter. In other words the pipe clamp keeps the flanges together and as such maintains the pipe connection via a compression fit.

The semicircular pipe clamp may be designed to couple pipes of the same or different diameters and or different flange diameters. According to one embodiment, the first and third curvatures are the same and the second and fourth curvatures are the same. According to another embodiment, the semicircular pipe clamp may couple pipe and or flanges of the same diameters, wherein a perimeter arc length for the first and third rings is the same as a perimeter arc length for the second and fourth rings.

According to one embodiment, if the ring curvatures are different in order to accommodate different flange diameters and or curvatures, in order to facilitate manufacturing of the rings and to provide the desired clamping grip, the total arc length perimeters may be approximately the same. So if one ring has less of a curvature than the other, then the ring with less of a curvature has a longer straight portion so that the total arc length perimeter is the same even if the curvatures are different. Accordingly, a perimeter arc length for the first and third rings may include a straight portion.

If the flanges have the same diameter and curvatures, then the first, second, third and fourth curvatures maybe approximately the same.

The relatively easy attachment is particularly advantageous for operators who repetitively clamp pipes. The relatively easy installation required for inserting the semicircular pipe clamp operable to couple a first pipe flange and a second pipe flange may result in fewer injuries to the assembly workers, including injuries related to repetitive stress syndrome. Further by selecting a single semicircular pipe clamp or reducing the number of different clamps for different size pipes and thicknesses, confusion during assembly is eliminated since the same type or a reduced number of semicircular pipe clamps may be used for all or most pipes.

The relatively high level of strength, characteristic of the pipe clamp, securely attaches to the pipes. Further, the pipe clamp quickly and easily snaps onto the pipe flanges and minimizes long tedious threading of screws or crimping and manual clamping of conventional pipe clamps. The pipe clamp resists flexing, pushing by operators, vibration and thermal expansion. The pipe clamp may also couple plastic and/or metal pipes. The pipe clamp may be made of anti-corrosive material such as plastic or treated metal to provide long reliable service life.

Yet another advantage is that the pipe clamp is relatively easy to manufacture using relatively inexpensive manufacturing processes and materials. The use of the pipe clamp decreases installation effort and time, assembly and production costs, increases worker productivity and efficiency, improves reliability and quality and decreases overall assembly, warranty and maintenance costs. The pipe clamp improves reliability both in the short term and in the long term, while further improving safety and quality.

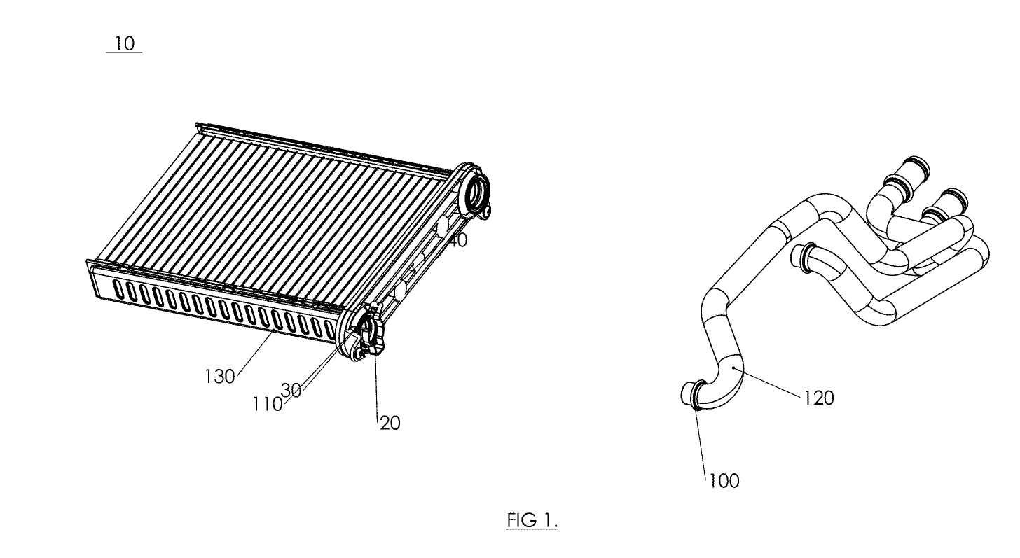

FIG. 1 is an exploded view of a semicircular pipe clamp assembly 10 according to one embodiment. A semicircular pipe clamp 20 is operable to couple with a first pipe flange 100 and a second pipe flange 110. The first pipe flange 100 and second pipe flange 110 are shown at the end of a pipe 120 and a heat exchanger 130 respectively. The first pipe flange 100 may be formed at the end of or part of a pipe 120. The second pipe flange 110 may be formed at the end of or part of a radiator heater core 130.

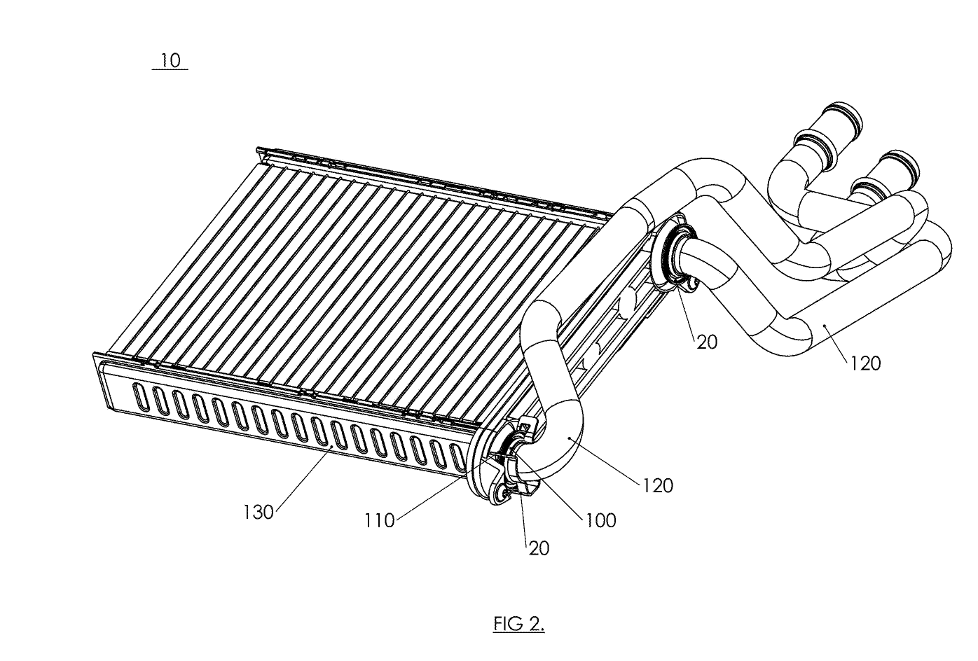

FIG. 2 is a partially assembled view of a semicircular pipe clamp assembly 10 operable to attach to a heat exchanger 130 with feed and return pipes to carry water, gas, air, coolant, antifreeze or any suitable medium.

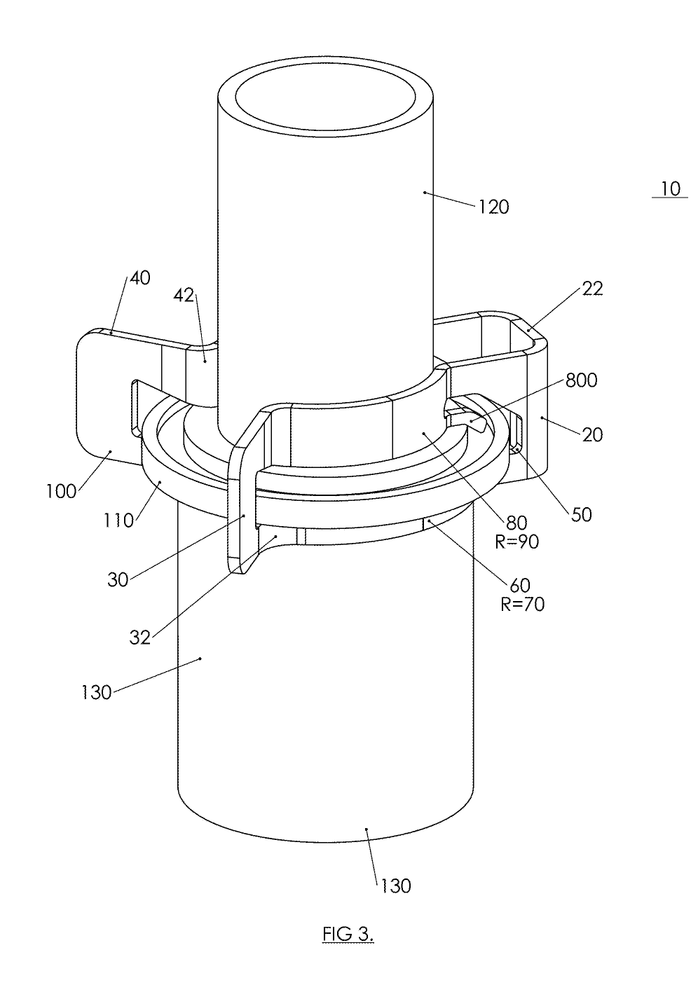

FIG. 3 is a perspective view of a semicircular pipe clamp assembly 10 according to one embodiment. The clamp 20 has a first end 30 and a second end 40 opposite the first end 30. The clamp 20 may have a U shape generally having a center 22 with curved slotted rings described below. The center 22 may be formed as a three sided rectangle to provide the desired springing force although the center 22 may be shaped as a V, W, curved or any suitable number of bends or curves.

Among other advantages, the semicircular pipe clamp 20 is oriented (shown vertically) or parallel to the axis of the pipes to hold the flanges 100, 110 together. For example, a rectangular beam, an I-beam or other beam where the vertical height is greater than the width or depth resists longitudinal forces compared to bending forces applied to the horizontally oriented clips. Examining the deflection shape of a beam model for each ring, for a force applied from the top of the generally beam it is possible to observe that longitudinal elements of the beam near the bottom are stretched and those near the top are compressed, thus indicating the simultaneous existence of both tensile and compressive stresses on transverse planes. A force applied from the bottom will likewise result in compression in the bottom ring and tension in the top ring. A force in the middle between the rings will result in compression in the rings closest to the flanges and tension in the rings on the side of the rings opposite the flange sides. The force in between the rings corresponds to the flanges 100, 110 shown in the figures as the flanges 100, 110 have forces separating the flanges and the rings are so strong as to prevent separation of the flanges. For example, examining the deflection shape of FIG. 4 where the flanges 100, 110 are pushing apart from each other, each ring has longitudinal elements of the ring away from the flanges and are stretched, or in tension and those near the flanges are compressed, thus indicating the simultaneous existence of both tensile and compressive stresses on transverse planes of each ring.

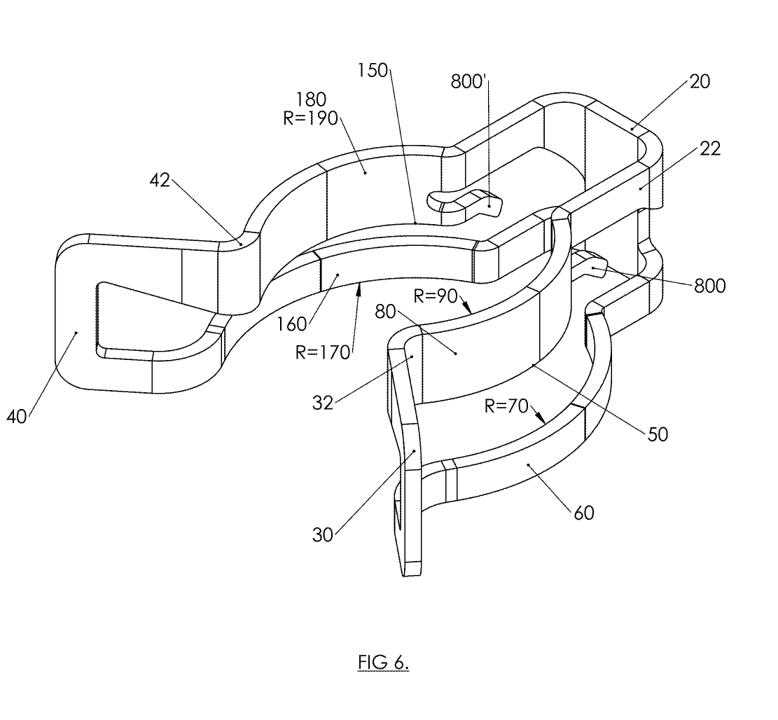

FIG. 4 is a side view of a semicircular pipe clamp assembly 10, pipe 120 and heat exchanger with pipe section 130. A semicircular pipe clamp 20 is operable to couple a first pipe flange 100 and a second pipe flange 110. Because the material, such as the steel rings 60, 160, 80, 180 (see FIG. 6) are oriented perpendicular to the flange surfaces 100, 110 rather than parallel as in conventional pipe clamps, the rings 60, 160, 80, 180 better resists separation and thus maintains the flanges 100, 100 in tight compression. Since the clamp 20 is taller than it is deep, the clamp 20 resists longitudinal bending. As a result, the pipe clamp 20 maintains the flanges 100, 100 in tension in the presence of age, vibration or temperature and is superior to clamps oriented parallel to the surface of the flanges 100, 110.

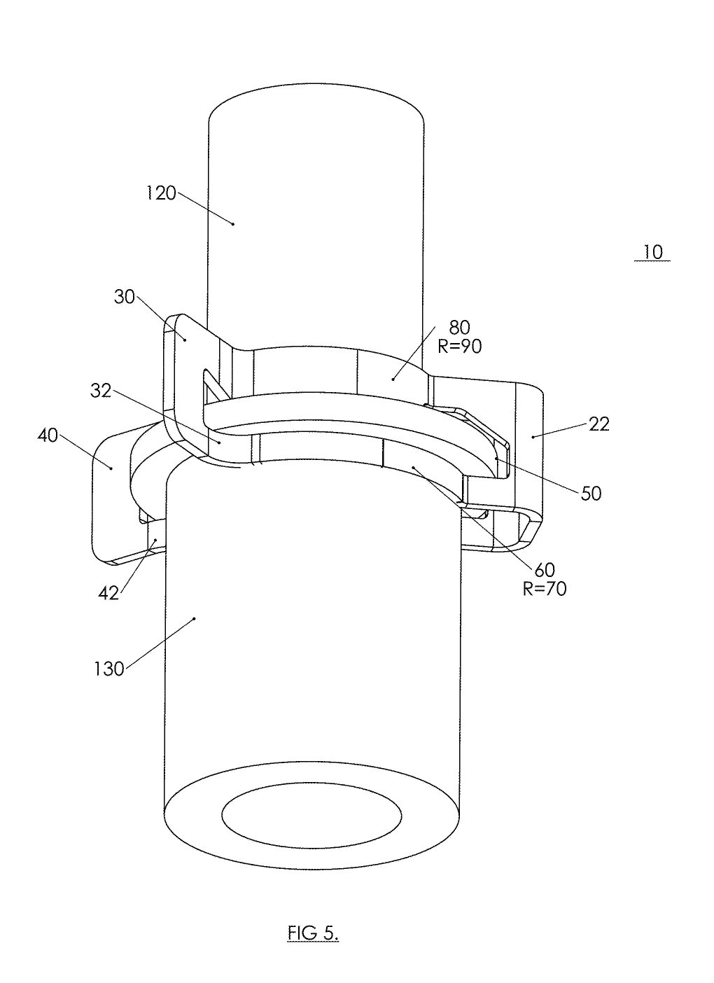

FIG. 5 is a bottom perspective view of a semicircular pipe clamp assembly according to one embodiment. The first 30 and second 40 ends are tapered, flared and/or bent 32, 42 to allow the pipe clamp 20 to spread open when snapped into the first 100 and second 110 pipe flanges. The length of the flares 32, 42 and the angle of the flares 32, 42 may be designed such that as the pipe clamp is pushed onto the flanges, the flares cause the rings to spread open as the rings are snapped over and onto the flanges 100, 110 and pipe. For example, the spacing between the flares 32, 42 at their widest point near the ends or tips may have a distance that is greater than the diameter of the flanges 100, 110 and/or pipe. Thus, upon selecting the desired arc length of each ring 60, 160, 80, 180, and the straight portion of each ring 60, 160, 80, 180, the flare 32, 42 length and angle may be determined based on the flare diameters plus some additional installation margin.

FIG. 6 is a perspective view of a semicircular pipe clamp 20 according to one embodiment. The first end 30 of the pipe clamp 20 has a first window 50 including a first ring 60 having a first curvature radius (r) 70 operable to engage the first pipe flange 100 and a second ring 80 having a second curvature radius (r) 90 opposite the first ring 60 operable to engage the second pipe flange 110. The second end 40 opposite the first end has a second window 150 including a third ring 160 having the third curvature radius (r) 170 operable to engage the first pipe flange 100; and a fourth ring radius (r) 180 having the fourth curvature 190 opposite the third ring 160 operable to engage the second pipe flange 110. The “r” or “R” in the drawings refers to a radius forming a curvature.

The first end 30 of the pipe clamp 20 has a first window 50 sized suitably to allow easy sliding or slipping onto flanges 110, 110 and to rigidly clamp the flanges 110, 110 when in an installed position. The first window 50 is formed by a first ring 60 and a second ring 80. The first ring 60 has a first curvature radius (r) 70 operable to engage the first pipe flange 100. The second ring 80 has a second curvature radius (r) 90 opposite the first ring 60 operable to engage the second pipe flange 110. The second end 40 is opposite the first end 30 and has a second window 150. The second window 150 is formed by a third ring 160 and a fourth ring 180. The third ring 160 has the first curvature radius (r) 170 operable to engage the first pipe flange 100. The fourth ring 180 has the second curvature radius (r) 190 opposite the second ring 80 operable to engage the second pipe flange 110.

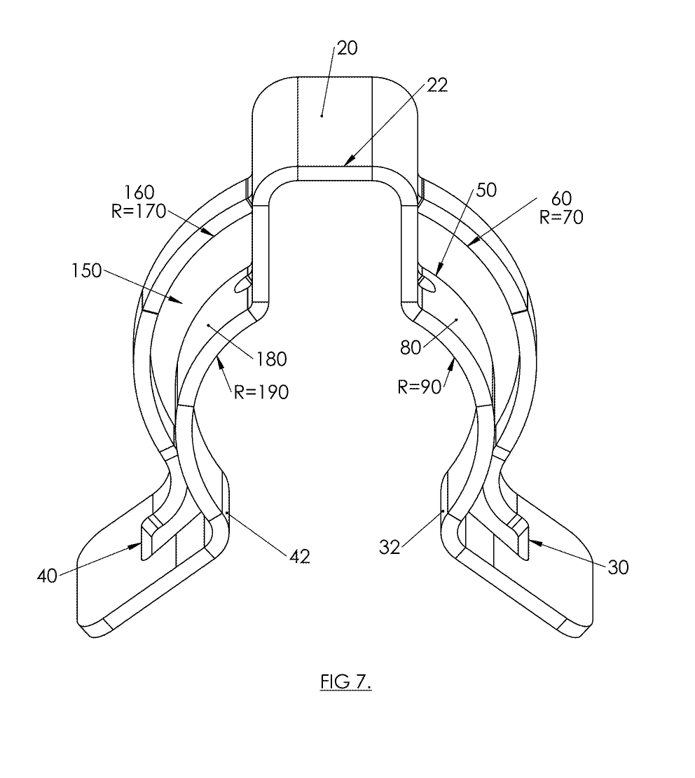

FIG. 7 is a side view of a semicircular pipe clamp 20. According to one embodiment, the first 70 and third curvatures 170 are operable to engage flange 110 and have a corresponding curvature with the pipe flange 110 and have a similar curvature. The second 90 and fourth 190 curvatures are the same and are operable to engage and have a corresponding curvature with the first pipe flange 100. As shown in FIG. 7 a perimeter arc length for the first 60 and third rings 160 is the same as a perimeter arc length for the second 80 and fourth 180 rings.

According to one embodiment, the flange 110 of one pipe 130 has a larger diameter than of the flange 100 on the other pipe 120 so the smaller diameter pipe 120 fits into the larger diameter pipe 130. As one skilled in the art would understand, a gasket between pipe 120, 130 provides a sufficient seal for any suitable application, such as for a radiator, heater core, intercooler, air conditioning condenser, compressor or any suitable device. As such the pipe clamp 20 keeps the pipes 120, 130 coupled together such that the gasket sufficiently seals the inner diameter pipe to the larger diameter outer pipe. For example, the outer diameter of pipe 120 is sized to fit to the inner diameter of pipe 130. As such the pipe clamp 20 keeps the flanges 100, 110 together tightly and as such maintains the pipe connection via a compression fit.

The semicircular pipe clamp 20 may be designed to couple pipes 120, 130 of the same or different diameters (using suitable diameter adapters) and or different flange diameters. According to one embodiment the first and third curvature pairs are the same and the second and fourth curvature pairs are the same, but different that the first and third curvature pairs. According to another embodiment, the semicircular pipe clamp 20 may couple pipe and or flanges of the same diameters, wherein a perimeter arc length for the first and third rings is the same as a perimeter arc length for the second and fourth and rings.

If the flanges have the same diameter and curvatures, then the first, second, third and fourth curvatures maybe the same.

According to one embodiment, if the ring curvatures are different in order to accommodate different flange diameters and or curvatures, in order to facilitate manufacturing of the rings, the total arc length perimeters may be the same. So if one ring has less of a curvature than the other then the ring with less of a curvature to the have a longer straight portion so that the total arc length perimeter is the same even if the curvatures are different. Accordingly, a perimeter arc length for the first and third rings may include a straight portion.

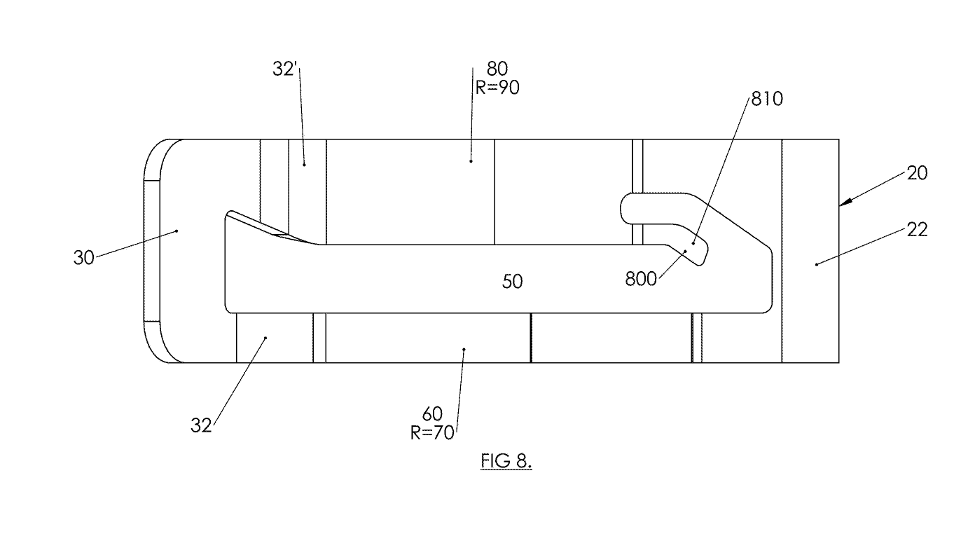

FIG. 8 is a longitudinal side view of a semicircular pipe clamp 20. The clamp 20 may further include a spring finger 800, 800′ formed on the second 80 and fourth 180 rings such that the spring finger 800, 800′ bends when inserted over the first pipe flange 100. According to one embodiment, the spring fingers 800, 800′ are tapered 810 to allow the spring finger 800, 800′ to pass over the first pipe flange 100 during insertion but then engages an inside pipe flange to prevent removal of the spring finger 800, 800′ and thus maintain the pipe clamp 20 to couple the first 100 and second 110 pipe flanges. The height and length of the spring finger 800, 800′ may be sized to provide the desired bending amount and springing force—elasticity. The pipe clamp 20 may be readily removed by lifting the spring finger 800, 800′ with a person's finger, thumb, a screw driver, a pry bar or any other suitable tool.

The clamp 20 may be comprised of at least one of: zinc die cast, machine steel, cast plastic or powdered metal, cindered (pressing powder together), plastic, vinyl, rubber, plastisol, plastic, acetal, polyacetal, polyoxymethylene, nylon, fiberglass and carbon fiber or any suitable material.

According to one embodiment the clamp 20 is formed from sheet metal. For example, the windows, the rings forming the windows and any other features such as the spring finger may be machine pressed or stamped. Advantageously, less material is required and the stamping or forming process requires fewer steps and this is less expensive to manufacture than conventional pipe coupling devices.

The semicircular pipe clamp may have the first pipe flange formed at the end of a radiator heater core and the second pipe flange is formed at the end of a connecting pipe. Thus, a radiator heater core and connecting pipe may quickly, reliably and easily be connected without screws, screw clamps or other time consuming assembly. As such the semicircular pipe clamp is less expensive to manufacture, reduces assembly costs, improves reliability and is more easily serviced than conventional clips.

Also, the installer can attach the clamp 20 with one hand whereas the prior art conventional clamps require two hands.

It is understood that the implementation of other variations and modifications of the present invention in its various aspects will be apparent to those of ordinary skill in the art and that the invention is not limited by the specific embodiments described. It is therefore contemplated to cover by the present invention any and all modifications, variations or equivalents that fall within the spirit and scope of the basic underlying principles disclosed and claimed herein.

We claim:

1. A semicircular pipe clamp operable to couple a first pipe flange and a second pipe flange comprising:
a first end of the pipe clamp having a first window including;
a first ring having a first curvature operable to engage the first pipe flange; and
a second ring having a second curvature opposite the first ring operable to engage the second pipe flange;
a second end opposite the first end having a second window including:
a third ring having a third curvature operable to engage the first pipe flange; and
a fourth ring having a fourth curvature opposite the third ring operable to engage the second pipe flange.

2. The semicircular pipe clamp of claim 1, wherein the first and third curvatures are the same as the second and fourth curvatures are the same.

3. The semicircular pipe clamp of claim 2, wherein a perimeter arc length for the first and third rings is the same as a perimeter arc length for the second and fourth rings.

4. The semicircular pipe clamp of claim 3, wherein a perimeter arc length for the first and third rings includes a straight portion.

5. The semicircular pipe clamp of claim 1, wherein the first, second, third and fourth curvatures are the same.

6. The semicircular pipe clamp of claim 1, wherein the clamp is formed from sheet metal.

7. The semicircular pipe clamp of claim 1, wherein the first pipe flange is formed at the end of a radiator heater core and the second pipe flange is formed at the end of a pipe.

8. The semicircular pipe clamp of claim 1, further comprising a spring finger formed on the first and third rings such that the spring finger bends when inserted over the first pipe flange.

9. The semicircular pipe clamp of claim 8, wherein the spring finger are tapered to allow the spring finger to pass over the first pipe flange during insertion but then engages an inside pipe flange to prevent removal of the spring finger and thus maintain the pipe clamp to couple the first and second pipe flanges.

10. The semicircular pipe clamp of claim 1, wherein the first and second ends are tapered to allow the pipe clamp to spread open when snapped into the first and second pipe flanges.

11. A semicircular pipe clamp assembly comprising:
a first pipe flange;
a second pipe flange;
a first end of the pipe clamp having a first window including;
a first ring having a first curvature operable to engage the first pipe flange; and
a second ring having a second curvature opposite the first ring operable to engage the second pipe flange;
a second end opposite the first end having a second window including:
a third ring having the first curvature operable to engage the first pipe flange; and
a fourth ring having the second curvature opposite the third ring operable to engage the second pipe flange.

12. The semicircular pipe clamp assembly of claim 11, wherein the first and third curvatures are the same and the second and the fourth curvatures are the same.

13. The semicircular pipe clamp assembly of claim 12, wherein a perimeter arc length for the first and third rings is the same as a perimeter arc length for the second and fourth and rings.

14. The semicircular pipe clamp assembly of claim 13, wherein a perimeter arc length for the first and third rings includes a straight portion.

15. The semicircular pipe clamp assembly of claim 11, wherein the first, second, third and fourth curvatures are the same.

16. The semicircular pipe clamp assembly of claim 11, wherein the clamp is formed from sheet metal.

17. The semicircular pipe clamp assembly of claim 11, wherein the first pipe flange is formed at the end of a radiator heater core and the second pipe flange is formed at the end of a pipe.

18. The semicircular pipe clamp assembly of claim 11, further comprising a spring finger formed on the first and third rings such that the spring finger bends when inserted over the first pipe flange.

19. The semicircular pipe clamp assembly of claim 18, wherein the spring finger are tapered to allow the spring finger to pass over the first pipe flange during insertion but then engages an inside pipe flange to prevent removal of the spring finger and thus maintain the pipe clamp to couple the first and second pipe flanges.

20. The semicircular pipe clamp assembly of claim 11, wherein the first and second ends are tapered to allow the pipe clamp to spread open when snapped into the first and second pipe flanges.
